(19) United States
(12) Patent Application Publication
(10) Pub. No.: US 2026/0318041 A1
(43) Pub. Date: Oct. 15, 2026

(54) CONTROL DEVICE AND METHOD FOR ENGINE COUPLING OF EXCAVATOR

(71) Applicant: XUZHOU XCMG EXCAVATOR MACHINERY CO., LTD., Jiangsu (CN)

(72) Inventors: Yadong LI, Jiangsu (CN); Jiawen GENG, Jiangsu (CN); Yuzhong DONG, Jiangsu (CN); Meng WEN, Jiangsu (CN); Zhao YU, Jiangsu (CN); Kaihan WANG, Jiangsu (CN); Cunkun JIA, Jiangsu (CN); Rui ZHANG, Jiangsu (CN)

(73) Assignee: XUZHOU XCMG EXCAVATOR MACHINERY CO., LTD., Jiangsu (CN)

(21) Appl. No.: 18/866,561

(22) PCT Filed: May 17, 2024
(86) PCT No.: PCT/CN2024/093822

§ 371 Date: Nov. 18, 2024

(30) Foreign Application Priority Data
Nov. 30, 2023 (CN) 202311622714.1

(51) Int. Cl. E02F 9/20; B60K 28/00; E02F 9/24; F02D 41/02; F02D 41/04

(52) U.S. Cl. CPC E02F 9/2066; B60K 28/00; E02F 9/24; F02D 41/021; F02D 41/042

(57) ABSTRACT

The present invention discloses a control device and method for engine coupling of an excavator. The control device includes a main controller, a switch control unit and an engine controller that are electrically connected with one another; by means of a bus, and an electronic monitor, an emergency stop switch and an emergency mode relay are connected onto the man controller. The intelligent start-stop control is achieved by start-stop of controller coupling, and meanwhile, the purpose of uninterrupted control power supplied to a system key switch during flame-out is achieved by coupling shutdown via the controllers; and when the controllers fail, a contact state of a safety relay can be converted to switch a power supply and start a loop, and a start-stop loop can be switched from coupling control to direct control by means of the emergency mode relay, thereby improving the reliability of a start-stop control system.

### TECHNICAL FIELD

The present invention belongs to the technical field of electric control for excavators, and in particular, relates to a control device and method for engine coupling of an excavator.

### RELATED ART

With the development of intelligentization technologies, the traditional electrical system of an excavator has been unable to better meet the needs of intelligentization development, a start-stop control system of the excavator achieves intelligent coupling control by means of a new intelligent architecture to truly achieve the goal of defining an intelligentized product with software, and the competitiveness of products can be greatly improved by developing the intelligentization technologies.

In the prior art, there are mainly two technical routes. In one of the technical routes, the start or flame-out is enabled under direct drive by means of a key switch, and such a system has a simpler electrical principle and better reliability, but is low in the degree of intelligence and unavailable for both intelligent start-stop and asynchronous control of power-off and flame-out, such that the requirement for flame-out without power interruption cannot be met. In the other technical route, the intelligent start control can be addressed by a control system that can be started by means of controller coupling; however, the flame-out is directly actuated using a key switch or other switch modules, and the asynchronous flame-out condition is not available; furthermore, a control mode has no redundancy, such that, when the controller fails, it is likely to cause false flame-out of the engine to thus present a control risk, or it is impossible to start or stop the engine in emergency to implement a danger avoidance operation; and the function and safety design cannot meet the safety requirements.

### SUMMARY OF INVENTION

An object of the present invention is to provide a control device and method for engine coupling of an excavator to achieve asynchronous control of power-off and flame-out while enabling emergency start-stop of an engine to implement the danger avoidance operation.

To achieve the above object, in a first aspect, the present invention employs a technical solution as follows: a control device for engine coupling of an excavator includes a main controller, a switch control unit and an engine controller that are electrically connected with one another, wherein the main controller is connected to the switch control unit and the engine controller by means of a bus, respectively;
a port P₄ of the switch control unit is electrically connected to a first set of normally-closed contacts of an emergency mode relay and a coil of a power supply relay, and the first set of normally-closed contacts of the emergency mode relay is electrically connected to a cathode of an isolated diode D4; an anode of the isolated diode D4 is electrically connected to a port DO2 of the main controller; a port P₂ of the switch control unit is electrically connected to a second set of normally-closed contacts of the emergency mode relay; the second set of normally-closed contacts of the emergency mode relay is electrically connected to a cathode of an isolated diode D5; an anode of the isolated diode D5 is electrically connected to a port DO1 of the main controller; a port P₃ of the switch control unit is electrically connected to a port DI1 of the main controller; a coil of the emergency mode relay is electrically connected to a port DO3 of the main controller; a port P₁ of the switch control unit is connected to an anode of a power supply;

the cathode of the isolated diode D5 is electrically connected to a control coil of a start unit of an engine;

the cathode of the isolated diode D4 is electrically connected to a normally-closed contact port H₁ of an emergency stop switch; a normally-closed contact port H₂ of the emergency stop switch is electrically connected to a port keysw of the engine controller; a normally-open contact port H₃ of the emergency stop switch is grounded; and a normally-open contact port H₄ of the emergency stop switch is electrically connected to a port DI2 of the main controller.

Preferably, ports CAN2H and CAN2L of the main controller are electrically connected to ports CANL and CANH of the engine controller, respectively.

Preferably, an electronic monitor is electrically connected to the main controller and the switch control unit; a port CANH of the electronic monitor is electrically connected to a port CANIH of the main controller and a port CANH of the switch control unit; and a port CANL of the electronic monitor is electrically connected to a port CANIL of the main controller and a port CANL of the switch control unit.

Preferably, the electronic monitor is provided with a human-machine interaction interface.

Preferably, the human-machine interaction interface is provided as a touch screen.

Preferably, the switch control unit includes an integrated switch panel SCU, a one-key start switch S1 and a power supply switch S2;

the port P₁of the switch control unit, the one-key start switch S1, an isolated diode D1 and the port P₄ of the switch control unit are electrically connected in sequence; an anode of the isolated diode D1 is electrically connected to the one-key start switch S1 and a port V₂ of the integrated switch panel SCU; a cathode of the isolated diode D1 is electrically connected to the port P₄ of the switch control unit;

the port P₁of the switch control unit, the power supply switch S2, an isolated diode D3 and the port P₂ of the switch control unit are electrically connected in sequence; an anode of the isolated diode D3 is electrically connected to the port P₃ of the switch control unit, the power supply switch S2 and a port V₁ of the integrated switch panel SCU; a cathode of the isolated diode D3 is electrically connected to the port P₂ of the switch control unit;

the port P₄ of the switch control unit, an isolated diode D2 and a port V₃ of the integrated switch panel SCU are electrically connected in sequence; a cathode of the isolated diode D2 is electrically connected to the port P₄ of the switch control unit, and an anode of the isolated diode D2 is electrically connected to the port V₃ of the integrated switch panel SCU; and ports CANH and CANL of the integrated switch panel SCU are provided as the ports CANH and CANL of the switch control unit.

Preferably, the integrated switch panel SCU, the one-key start switch S1 and the power supply switch S2 are integrated on a control panel.

Preferably, the one-key start switch S1 is provided as a self-resetting key with a redundant function.

In a second aspect, the present invention provides a control method for engine coupling of an excavator. The control method includes:

turning on the power supply switch S1 of the switch control unit to subsequently power on an excavator system, and turning on the one-key start switch S2, when the port P₃ of the switch control unit transmits a start signal to the port DI1 of the main controller, receiving and detecting a rotating speed signal of the engine controller to determine an engine state; if the engine is in a stop state, outputting a high level by a port DO3 of the main controller to the port keysw of the engine controller by means of the normally-closed contacts of the emergency stop switch, and starting the engine of the excavator by means of the engine controller; if the engine is in an operating state, sending an early warning to the electronic monitor by means of a bus;

when the main controller receives the start signal from the switch control unit by means of the bus and the port DI1 of the main controller hasn't received the start signal of the switch control unit, sending an emergency state to the electronic monitor by means of the bus; and operating based on start/stop selected by means of the electronic monitor.

Preferably, when the engine flames out, the one-key start switch S2 is turned off, and when the port P₃of the switch control unit transmits a flame-out signal to the port DI1 of the main controller, the rotating speed signal of the engine controller is received and detected to determine the engine state; if the engine is in the operating state, the port DO3 of the main controller is controlled to power off, and the engine controller controls the engine of the excavator to flame out; and if the engine is in the stop state, the early warning is sent to the electronic monitor by means of the bus.

Preferably, when the emergency stop switch is pressed, an emergency stop signal is received by the port DI2 of the main controller, the rotating speed signal of the engine controller is received and detected to determine the engine state; if the engine is in the operating state, an emergency flame-out state is sent to the electronic monitor by means of the main controller; and that the engine flames out in emergency is verified by means of a redundant flame-out mode of the electronic monitor, and then, an emergency shutdown instruction is sent to the engine controller by means of a bus between the engine controller and the main controller so as to control the engine to flame out in emergency.

Preferably, when the main controller fails, the coil of the emergency mode relay is controlled to power off to allow for a closed state of the normally-closed contacts of the emergency mode relay, a start-stop signal is sent by the switch control unit to the port keysw of the engine controller by means of the emergency mode relay and the emergency stop switch, and meanwhile, the port P₂of the switch control unit is connected to a coil of the start unit by means of normally-closed contacts of the safety relay to convert to direct control of the engine by the switch control unit, thereby directly controlling the engine to start and flame out by means of the power supply switch of the switch control unit and the one-key start switch.

Compared with the prior art, the present invention achieves the following beneficial effects:
according to the present invention, the separate control of power control and engine start-stop is achieved by the independent design of a power-on switch and a start-stop switch, intelligent start-stop control is further achieved by start-stop of controller coupling, and meanwhile, the purpose of uninterrupted control power supplied to a system key switch during flame-out is achieved by stopping controller coupling.

The present invention constructs a multi-stage redundant design, in which an engine flame-out control port and bus redundancy control are used such that, when the emergency stop switch is abnormal, instruments can be operated by means of a human-machine interaction interface to allow for emergency flame-out by the controller via the bus; meanwhile, the emergency mode relay is provided such that, when the controller fails, a contact state of a safety relay can be converted to switch a power supply and start a loop, and a start-stop loop can be switched from coupling control to direct control, allowing that after the controller fails, the engine can be still started by means of the start-stop switch to carry out some emergency action control, thereby improving the reliability of a start-stop control system.

### BRIEF DESCRIPTION OF DRAWINGS

FIG. 1 is a structural diagram of a control device for engine coupling of an excavator according to Embodiment 1;

FIG. 2 is a circuit diagram of the control device for engine coupling of the excavator according to Embodiment 1;

FIG. 3 is a circuit diagram of a switch control unit according to Embodiment 1;

FIG. 4 is a structural diagram of a control panel according to Embodiment 1;

FIG. 5 is a flowchart of starting an engine of an excavator according to Embodiment 2;

FIG. 6 is a flowchart of redundant flame-out of the engine of the excavator according to Embodiment 2; and

FIG. 7 is a flowchart of emergency flame-out of the engine of the excavator according to Embodiment 2.

In the figures, reference signs are as follows: 1, main controller; 2, electronic monitor; 3, start unit; 4, engine controller; 5, emergency stop switch; 6, switch control unit; 7, power supply relay; and 8, emergency mode relay.

### DESCRIPTION OF EMBODIMENTS

The present invention will be further described below in conjunction with the accompanying drawings. The embodiments below are merely for the purpose of more clearly illustrating the technical solutions of the present invention, and are not intended to limit the protection scope of the present invention.

It should be noted that terms such as “front”, “back”, “left”, “right”, “top”, “bottom”, “inside”, “outside” and the like indicate direction or position relations based on the direction or position relations as shown in the accompanying drawings only for the sake of describing the present invention, instead of requesting the present invention to be necessarily constructed and operated in a specific direction. Therefore, these terms should not be construed as limiting the present invention. The terms such as “front”, “back”, “left”, “right”, “upper”, and “lower” used in the description of the present invention refer to directions in the accompanying drawings, and the term “inside” or “outside” refers to a direction towards or away from the geometrical center of a specific component, respectively.

### Embodiment 1

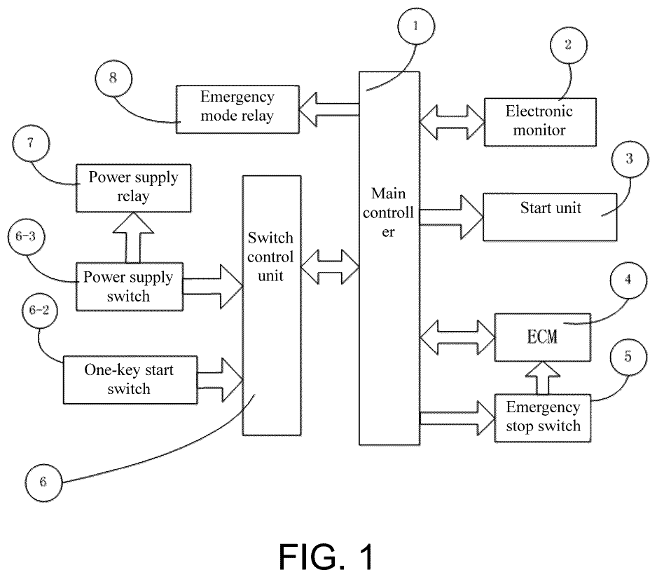

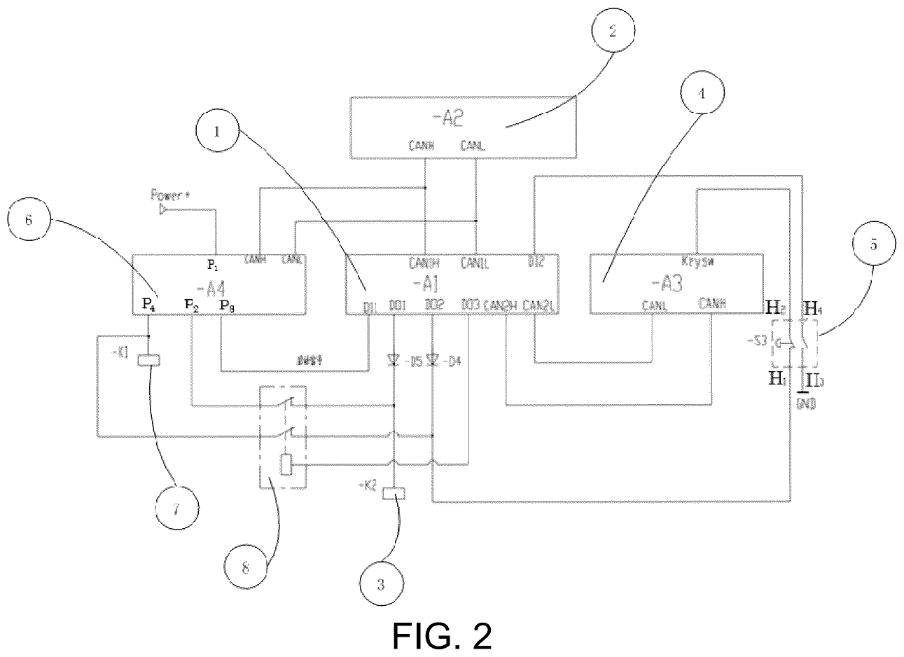

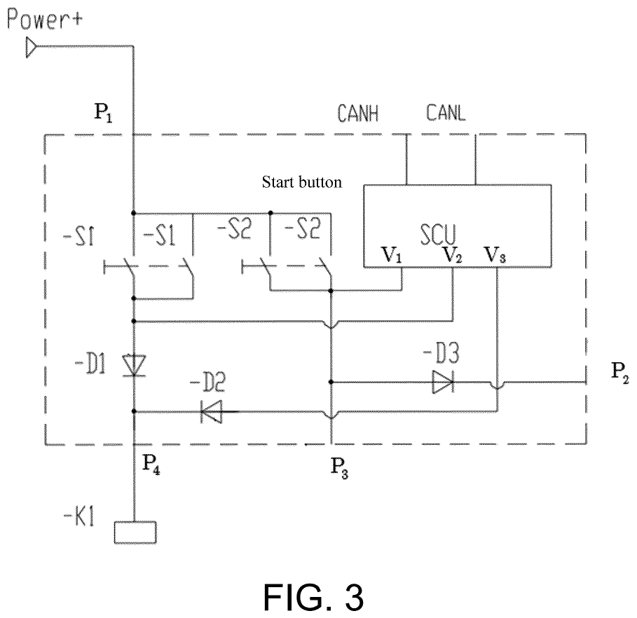

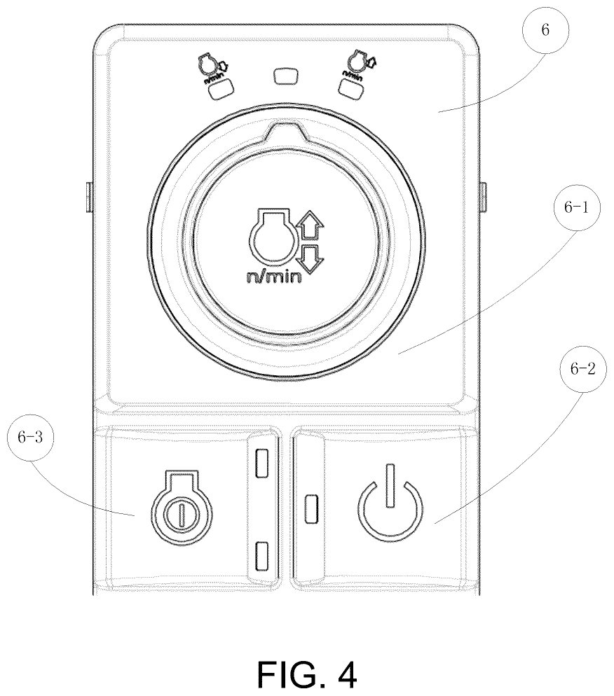

As shown in FIGS. 1-4, a control device for engine coupling of an excavator includes a main controller 1, a switch control unit 6 and an engine controller 4 that are electrically connected with one another; the main controller 1 is connected to the switch control unit 6 and the engine controller 4 by means of a bus, respectively; and ports CAN2H and CAN2L of the main controller are electrically connected to ports CANL and CANH of the engine controller, respectively.

The switch control unit 6 includes an integrated switch panel SCU, a one-key start switch S1 and a power supply switch S2; the integrated switch panel SCU, the one-key start switch S1 and the power supply switch S2 are integrated on a control panel; and the one-key start switch S1 is provided as a self-resetting key with a redundant function.

The port P₁of the switch control unit 6, the one-key start switch S1, an isolated diode DI and the port P₄ of the switch control unit 6 are electrically connected in sequence; an anode of the isolated diode D1 is electrically connected to the one-key start switch S1 and a port V₂ of the integrated switch panel SCU; and a cathode of the isolated diode D1 is electrically connected to the port P₄ of the switch control unit 6.

The port P₁of the switch control unit 6, the power supply switch S2, an isolated diode D3 and the port P₂ of the switch control unit 6 are electrically connected in sequence; an anode of the isolated diode D3 is electrically connected to the port P₃ of the switch control unit 6, the power supply switch S2 and a port V₁ of the integrated switch panel SCU; and a cathode of the isolated diode D3 is electrically connected to the port P₂ of the switch control unit 6.

The port P₄ of the switch control unit 6, an isolated diode D2 and a port V₃ of the integrated switch panel SCU are electrically connected in sequence; a cathode of the isolated diode D2 is electrically connected to the port P₄ of the switch control unit 6, and an anode of the isolated diode D2 is electrically connected to the port V₃ of the integrated switch panel SCU; and ports CANH and CANL of the integrated switch panel SCU are provided as the ports CANH and CANL of the switch control unit 6.

A port P₄of the switch control unit 6 is electrically connected to a first set of normally-closed contacts of an emergency mode relay 8 and a coil of a power supply relay 7, and the first set of normally-closed contacts of the emergency mode relay 8 is electrically connected to a cathode of an isolated diode D4; an anode of the isolated diode D4 is electrically connected to a port DO2 of the main controller; a port P₂ of the switch control unit 6 is electrically connected to a second set of normally-closed contacts of the emergency mode relay 8; the second set of normally-closed contacts of the emergency mode relay 8 is electrically connected to a cathode of an isolated diode D5; an anode of the isolated diode D5 is electrically connected to a port DO1 of the main controller; a port P₃ of the switch control unit 6 is electrically connected to a port DI1 of the main controller; a coil of the emergency mode relay 8 is electrically connected to a port DO3 of the main controller; and a port P₁ of the switch control unit 6 is connected to an anode of a power supply.

The cathode of the isolated diode D5 is electrically connected to a control coil of a start unit 3 of an engine.

The cathode of the isolated diode D4 is electrically connected to a normally-closed contact port H₁ of an emergency stop switch 5; a normally-closed contact port H₂ of the emergency stop switch 5 is electrically connected to a port keysw of the engine controller 4; a normally-open contact port H₃ of the emergency stop switch 5 is grounded; and a normally-open contact port H₄ of the emergency stop switch 5 is electrically connected to a port DI2 of the main controller.

An electronic monitor 2 is electrically connected to the main controller 1 and the switch control unit 6; a port CANH of the electronic monitor 2 is electrically connected to a port CANIH of the main controller 1 and a port CANH of the switch control unit 6; a port CANL of the electronic monitor 2 is electrically connected to a port CANIL of the main controller 1 and a port CANL of the switch control unit 6; and the electronic monitor 2 is provided with a human-machine interaction interface, which is provided as a touch or non-touch screen.

In this embodiment, the separate control of power control and engine start-stop is achieved by the independent design of a power-on switch and a start-stop switch, intelligent start-stop control is further achieved by start-stop of controller coupling, and meanwhile, the purpose of uninterrupted control power supplied to a system key switch during flame-out is achieved by stopping controller coupling.

### Embodiment 2

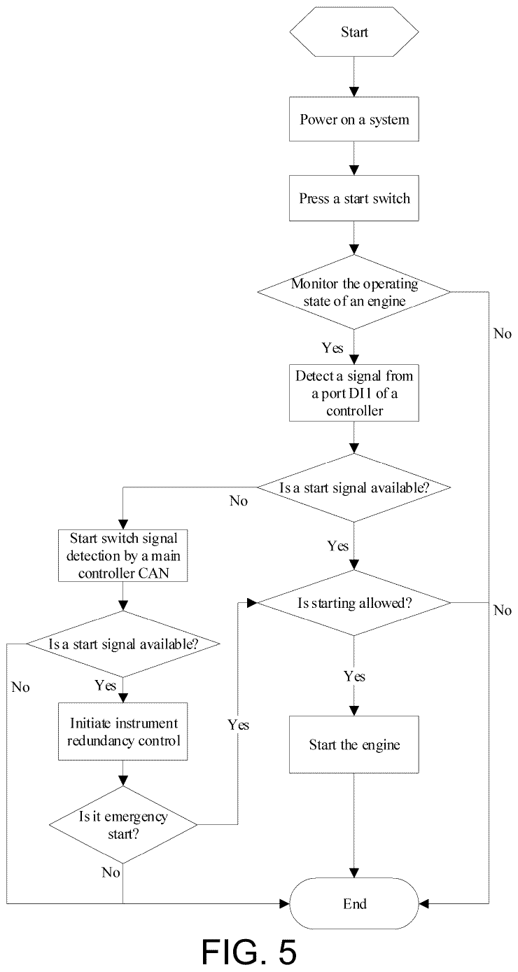

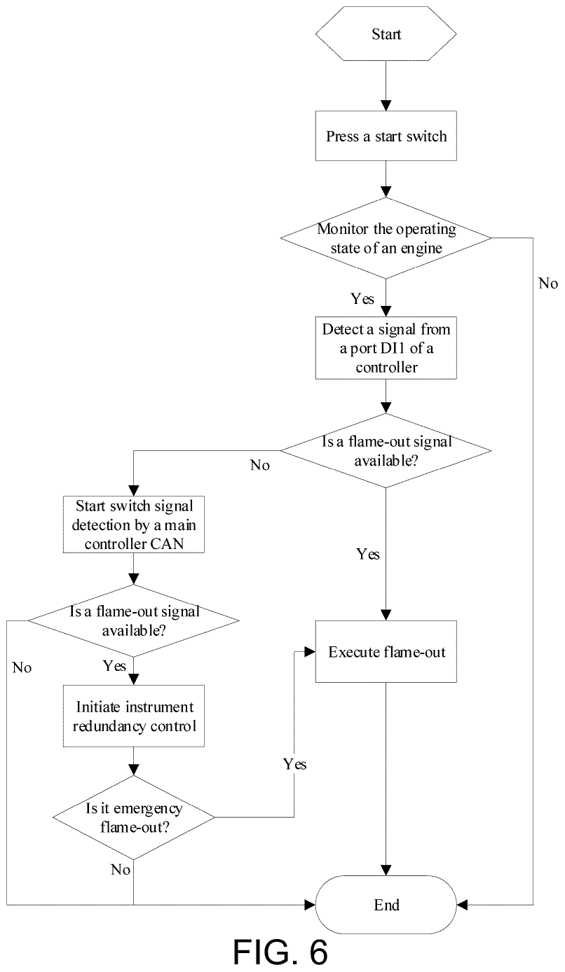

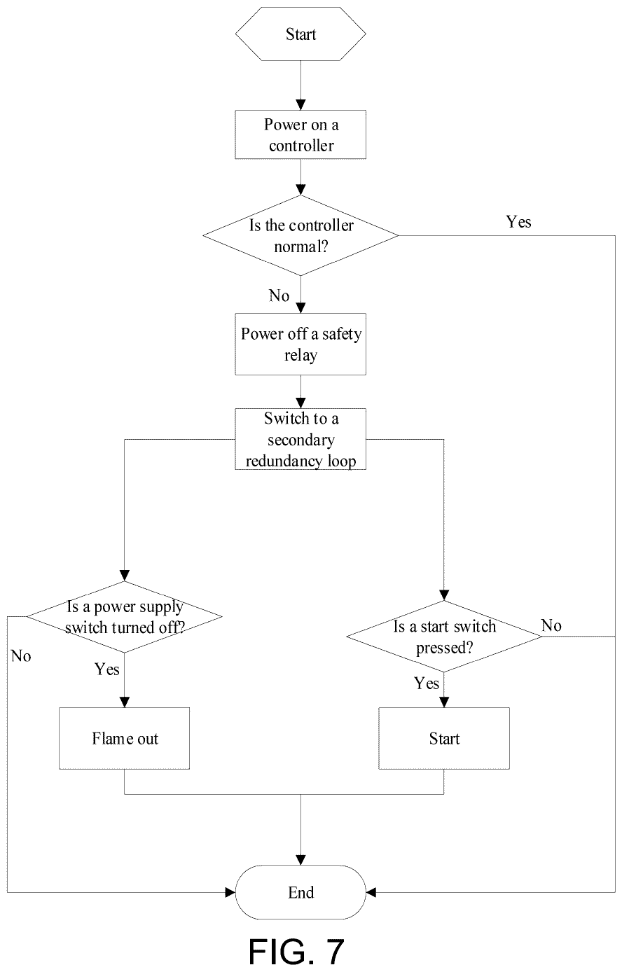

A control method for engine coupling of an excavator is shown as in FIGS. 5-7, and the control device described in embodiment 1 can be used in the control method provided by the present invention. The control method for engine coupling of the excavator includes:
turning on the power supply switch S1 of the switch control unit 6 to subsequently power on an excavator system, and turning on the one-key start switch S2;
when the port P₃of the switch control unit 6 transmits a start signal to the port DI1 of the main controller, receiving and detecting a rotating speed signal of the engine controller 4 to determine an engine state; if the engine is in a stop state, outputting a high level by a port DO3 of the main controller to the port keysw of the engine controller 4 by means of the normally-closed contacts of the emergency stop switch 5, and starting the engine of the excavator by means of the engine controller 4; if the engine is in an operating state, sending an early warning to the electronic monitor 2 by means of a bus;
when the main controller receives the start signal from the switch control unit 6 by means of the bus and the port DI1 of the main controller hasn't received the start signal of the switch control unit 6, sending an emergency state to the electronic monitor 2 by means of the bus; and operating based on start/stop selected by means of the electronic monitor 2.

When the engine flames out, the one-key start switch S2 is turned off, and when the port P₃of the switch control unit 6 transmits a flame-out signal to the port DI1 of the main controller, the rotating speed signal of the engine controller is received and detected to determine the engine state; if the engine is in the operating state, the port DO3 of the main controller is controlled to power off, and the engine controller 4 controls the engine of the excavator to flame out; and if the engine is in the stop state, the early warning is sent to the electronic monitor 2 by means of the bus.

When the emergency stop switch 5 is pressed, an emergency stop signal is received by the port DI2 of the main controller, the rotating speed signal of the engine controller 4 is received and detected to determine the engine state; if the engine is in the operating state, an emergency flame-out state is sent to the electronic monitor 2 by means of the main controller; and that the engine flames out in emergency is verified by means of a redundant flame-out mode of the electronic monitor 2, and then, an emergency shutdown instruction is sent to the engine controller 4 by means of a bus between the engine controller and the main controller so as to control the engine to flame out in emergency.

Preferably, when the main controller fails, the coil of the emergency mode relay 8 is controlled to power off to allow for a closed state of the normally-closed contacts of the emergency mode relay, a start-stop signal is sent by the switch control unit 6 to the port keysw of the engine controller 4 by means of the emergency mode relay 8 and the emergency stop switch 5, and meanwhile, the port P₂of the switch control unit is connected to a coil of the start unit 3 by means of normally-closed contacts of the safety relay to convert to direct control of the engine by the switch control unit 6, thereby directly controlling the engine to start and flame out by means of the power supply switch of the switch control unit 6 and the one-key start switch.

In this embodiment, a multi-stage redundant design is constructed, in which an engine flame-out control port and bus redundancy control are used such that, when the emergency stop switch is abnormal, instruments can be operated by means of a human-machine interaction interface to allow for emergency flame-out by the controller via the bus; meanwhile, the emergency mode relay is provided such that, when the controller fails, a contact state of a safety relay can be converted to switch a power supply and start a loop, and a start-stop loop can be switched from coupling control to direct control, allowing that after the controller fails, the engine can be still started by means of the start-stop switch to carry out some emergency action control, thereby improving the reliability of a start-stop control system.

Described above are only preferred embodiments of the present invention. For those of ordinary skills in the art, it should be noted that various improvements and variations can be made without departing from the technical principle of the present invention, and shall be construed as falling within the protection scope of the present invention.

1. A control device for engine coupling of an excavator, comprising a main controller, a switch control unit and an engine controller that are electrically connected with one another, wherein the main controller is connected to the switch control unit and the engine controller by means of a bus, respectively;
a port P₄ of the switch control unit is electrically connected to a first set of normally-closed contacts of an emergency mode relay and a coil of a power supply relay, and the first set of normally-closed contacts of the emergency mode relay is electrically connected to a cathode of an isolated diode D4; an anode of the isolated diode D4 is electrically connected to a port DO2 of the main controller; a port P₂ of the switch control unit is electrically connected to a second set of normally-closed contacts of the emergency mode relay; the second set of normally-closed contacts of the emergency mode relay is electrically connected to a cathode of an isolated diode D5; an anode of the isolated diode D5 is electrically connected to a port DO1 of the main controller; a port P₃ of the switch control unit is electrically connected to a port DI1 of the main controller; a coil of the emergency mode relay is electrically connected to a port DO3 of the main controller; a port P₁ of the switch control unit is connected to an positive of a power supply;
the cathode of the isolated diode D5 is electrically connected to a control coil of a start unit of an engine;
the cathode of the isolated diode D4 is electrically connected to a normally-closed contact port H₁ of an emergency stop switch; a normally-closed contact port H₂ of the emergency stop switch is electrically connected to a port keysw of the engine controller; a normally-open contact port H₃ of the emergency stop switch is grounded; and a normally-open contact port H₄ of the emergency stop switch is electrically connected to a port DI2 of the main controller.

2. The control device for engine coupling of the excavator according to claim 1, wherein ports CAN2H and CAN2L of the main controller are electrically connected to ports CANL and CANH of the engine controller, respectively.

3. The control device for engine coupling of the excavator according to claim 1, wherein an electronic monitor is electrically connected to the main controller and the switch control unit; a port CANH of the electronic monitor is electrically connected to a port CANIH of the main controller and a port CANH of the switch control unit; and a port CANL of the electronic monitor is electrically connected to a port CANIL of the main controller and a port CANL of the switch control unit.

4. The control device for engine coupling of the excavator according to claim 1, wherein the switch control unit comprises an integrated switch panel SCU, a one-key start switch S1 and a power supply switch S2;
the port P₁ of the switch control unit, the one-key start switch S1, an isolated diode D1 and the port P₄ of the switch control unit are electrically connected in sequence; an anode of the isolated diode D1 is electrically connected to the one-key start switch S1 and a port V₂ of the integrated switch panel SCU; a cathode of the isolated diode D1 is electrically connected to the port P₄ of the switch control unit;
the port P₁ of the switch control unit, the power supply switch S2, an isolated diode D3 and the port P₂ of the switch control unit are electrically connected in sequence; an anode of the isolated diode D3 is electrically connected to the port P₃ of the switch control unit, the power supply switch S2 and a port V₁ of the integrated switch panel SCU; a cathode of the isolated diode D3 is electrically connected to the port P₂ of the switch control unit;
the port P₄ of the switch control unit, an isolated diode D2 and a port V₃ of the integrated switch panel SCU are electrically connected in sequence; a cathode of the isolated diode D2 is electrically connected to the port P₄ of the switch control unit, and an anode of the isolated diode D2 is electrically connected to the port V₃ of the integrated switch panel SCU; and ports CANH and CANL of the integrated switch panel SCU are provided as ports CANH and CANL of the switch control unit.

5. The control device for engine coupling of the excavator according to claim 4, wherein the integrated switch panel SCU, the one-key start switch S1 and the power supply switch S2 are integrated on a control panel.

6. The control device for engine coupling of the excavator according to claim 5, wherein the one-key start switch S1 is provided as a self-resetting key with a redundant function.

7. A control method for the control device for engine coupling of the excavator according to claim 4, comprising:
turning on the power supply switch S2 of the switch control unit to subsequently power on an excavator system, while turning on the one-key start switch S1,
when the port P₃ of the switch control unit transmits a start signal to the port DI1 of the main controller, receiving and detecting a rotating speed signal of the engine controller to determine an engine state; if the engine is in a stop state, outputting a high level by the port DO3 of the main controller to the port keysw of the engine controller by means of normally-closed contacts of the emergency stop switch, and starting the engine of the excavator by means of the engine controller; if the engine is in an operating state, sending an early warning to an electronic monitor by means of the bus;
when the main controller receives the start signal from the switch control unit by means of the bus and the port DI1 of the main controller hasn't received the start signal of the switch control unit, sending an emergency state to the electronic monitor by means of the bus; and operating based on start/stop selected by means of the electronic monitor.

8. The control method according to claim 7, further comprising: when the engine flames out, turning off the one-key start switch S1, and when the port P₃ of the switch control unit transmits a flame-out signal to the port DI1 of the main controller, receiving and detecting the rotating speed signal of the engine controller to determine the engine state; if the engine is in the operating state, controlling to power off the port DO3 of the main controller, and controlling, by the engine controller, the engine of the excavator to flame out; and if the engine is in the stop state, sending the early warning to the electronic monitor by means of the bus.

9. The control method according to claim 7, further comprising: when the emergency stop switch is pressed, receiving an emergency stop signal by the port DI2 of the main controller, receiving and detecting the rotating speed signal of the engine controller to determine the engine state; if the engine is in the operating state, sending an emergency flame-out state to the electronic monitor by means of the main controller; and verifying, by means of a redundant flame-out mode of the electronic monitor, that the engine flames out in emergency, and then, sending an emergency shutdown instruction to the engine controller by means of a bus between the engine controller and the main controller so as to control the engine to flame out in emergency.

10. The control method according to claim 7, further comprising: when the main controller fails, controlling the coil of the emergency mode relay to power off to allow for a closed state of the normally-closed contacts of the emergency mode relay, sending a start-stop signal, by the switch control unit, to the port keysw of the engine controller by means of the emergency mode relay and the emergency stop switch, and meanwhile, connecting the port P₂ of the switch control unit to a coil of the start unit by means of normally-closed contacts of a safety relay to convert to direct control of the engine by the switch control unit, thereby directly controlling the engine to start and flame out by means of the power supply switch S2 and the one-key start switch S1 of the switch control unit.
